(19) United States
(12) Patent Application Publication
(10) Pub. No.: US 2012/0271574 A1
(43) Pub. Date: Oct. 25, 2012

(54) Real-Time and Off-Line Tools for Monitoring and Analysis of Power System Components

(75) Inventors: Olin Alvin Williams, JR., Lawrenceville, GA (US); Michael Jack Swan, Woodstock, GA (US)

(73) Assignee: Southern Company Services, Inc., Atlanta, GA (US)

(21) Appl. No.: 13/089,435

(22) Filed: Apr. 19, 2011

(51) Int. Cl. G06F 19/00

(52) U.S. Cl. 702/60

(57) ABSTRACT

Various methods and systems are provided for impulse response monitoring in power systems. In one embodiment, a method includes obtaining raw power system data associated with a power system, cross-correlating the raw power system data with a synchronized pseudo-random sequence signal injected into the power system to determine a correlated impulse response and determining a condition of the power system based at least in part upon the correlated impulse response. In another embodiment, a system includes a plurality of signal injection systems and a data capture device coupled to a power system. A data analysis device cross-correlates raw power system data obtained by the data capture device with at least one synchronized pseudo-random sequence signal injected by a signal injection system and determines a condition of the power system based at least in part upon a frequency spectrum based upon a correlated impulse response.

### BACKGROUND

Electric utilities operating a power grid take measurements of power system parameters such as voltage, current and phase angle information at various points throughout their operating territories and apply them to mathematical models of the power system, its connectivity, and its various components. Information derived from these models is then used as a means of monitoring the power system and providing information for operators and coordinators.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a drawing of a system for impulse response and frequency monitoring in a power system according to various embodiments of the present disclosure.

FIG. 2 is a graphical representation illustrating an example of synchronized pseudo-random sequence (PRS) signal injection into the power system of FIG. 1 according to various embodiments of the present disclosure.

FIG. 3 is graphical plots of an example of a PRS for injection into the power system of FIG. 1 according to various embodiments of the present disclosure.

FIG. 4 is a graphical representation illustrating an example of generating various uncorrelated PRS signals in the PRS generator of FIG. 2 using a linear feedback shift register (LFSR) in accordance with various embodiments of the present disclosure.

FIG. 5 is a graphical representation illustrating an example of a signal conditioning interface of FIGS. 2 and 8 according to various embodiments of the present disclosure.

FIG. 6 is graphical plots of an example of the PRS of FIG. 3 after conditioning by the signal conditioning interface of FIG. 5 according to various embodiments of the present disclosure.

FIG. 7 is a graphical representation illustrating an example of a coupling capacitor voltage transformer (CCVT) used as a power system interface of FIGS. 2 and 8 according to various embodiments of the present disclosure.

FIG. 8 is a graphical representation illustrating an example of synchronized raw power system data capture from the power system of FIG. 1 according to various embodiments of the present disclosure.

FIG. 9 is graphical plots of an example of raw power system data captured and correlated by the embodiment of FIG. 8 according to various embodiments of the present disclosure.

FIG. 10 is graphical plots of an example of frequency spectrums of the captured and correlated raw power system data of FIG. 9 according to various embodiments of the present disclosure.

FIG. 11 is a graphical plot of an example of a least squares difference of frequency spectrums of correlated impulse responses according to various embodiments of the present disclosure.

FIGS. 12 and 13 are graphical plots of examples of correlated impulse response frequency spectrums of a coupling capacitor voltage transformer (CCVT) of FIG. 7 operating with various capacitor conditions according to various embodiments of the present disclosure.

FIGS. 14-16 are graphical representations illustrating examples of real-time and off-line power system impulse and frequency response monitoring and analysis in accordance with various embodiments of the present disclosure

FIG. 17 is a flowchart illustrating examples of functionality implemented as portions of a data capture application and/or a data analysis application executed in one or more computing device(s) in the synchronized data capture and/or analysis of FIG. 8 according to various embodiments of the present disclosure.

FIG. 18 is a graphical representation of a networked environment for synchronized PRS signal injection and/or raw power system data capture for the power system of FIG. 1 according to various embodiments of the present disclosure.

FIG. 19 is a schematic block diagram that provides one example illustration of a computing device employed in the synchronized data capture and/or analysis of FIG. 8 according to various embodiments of the present disclosure.

### DETAILED DESCRIPTION

Disclosed herein are various embodiments of methods related to impulse response monitoring in power systems. Reference will now be made in detail to the description of the embodiments as illustrated in the drawings, wherein like reference numbers indicate like parts throughout the several views.

Introducing a low level of electrical white noise to a power system can cause electrical elements of the system to resonate (or ring) at their characteristic frequencies. The resulting resonant response can be analyzed to identify and monitor elements of the power system being stimulated by the introduced signal. The power system elements can include, but are not limited to, coupling capacitor voltage transformers (CCVT), switched capacitor banks, tap-changing transformers, circuit breakers, transmission lines, and other power system components as can be appreciated. Using pattern recognition techniques, abnormal and failing elements can be detected and identified before substantially affecting the power system. In addition, changes in the configuration of the power system network may also be detected and identified. Such detection and identification may be carried out continuously and in real time.

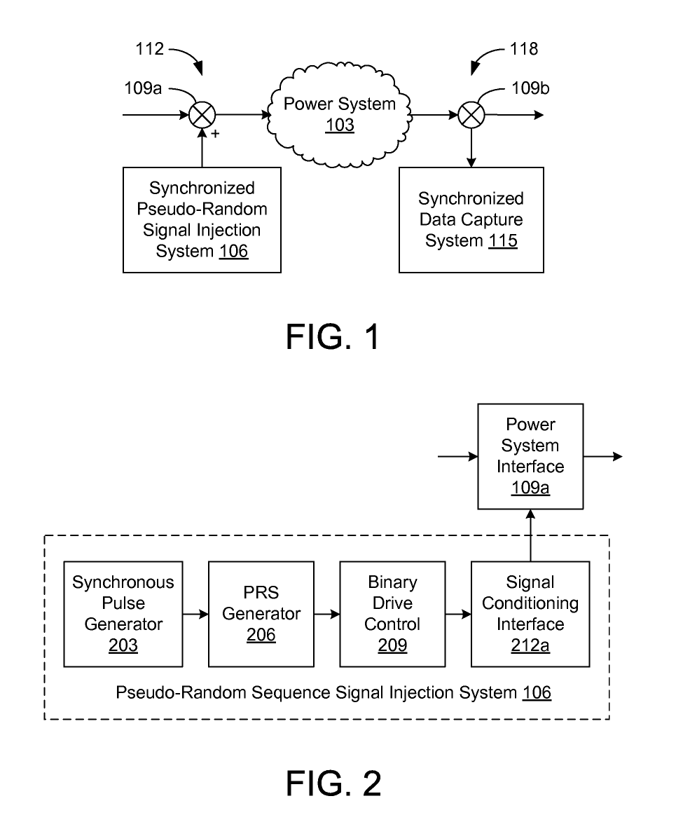

Referring to FIG. 1, shown is a graphical representation illustrating impulse signal injection for monitoring a power system 103 in accordance with various embodiments of the present disclosure. Independent of the power flow through the power system 103, a pseudo-random sequence (PRS) signal is injected by system 106 into the power system 103 through a power system interface 109a in a transmission path 112 (e.g., a HV transmission line, bus, or other appropriate access point). The injected signal is a relatively low-level noise signal such as a PRS signal. After propagating through the power system 103, the resulting signal is obtained at another point 118 along the transmission path for analysis (e.g., through another power system interface 109b by a data capture system 115). The PRS signal injection system 106 and the data capture system 115 are synchronized to facilitate analysis of the captured data. The analysis may be used to provide a real-time indication of the state of the power system 103 as described in U.S. Pat. No. 7,848,897, entitled “Dynamic Real-Time Power System Monitoring” and issued on Dec. 7, 2010, the entirety of which is hereby incorporated by reference.

The impulse response of the power system 103 can be determined by adding a random noise signal to the power system 103 through the power system interface 109a and cross-correlating the captured data with the additive random noise input signal. Pseudo-random discrete interval binary noise sequences can be used effectively as the noise input signal. Using cross-correlation and other techniques on the sampled data, impulse and frequency response characteristics of the power system and its components can be determined. For example, taking a Fourier transform of the impulse response yields the frequency response of the system.

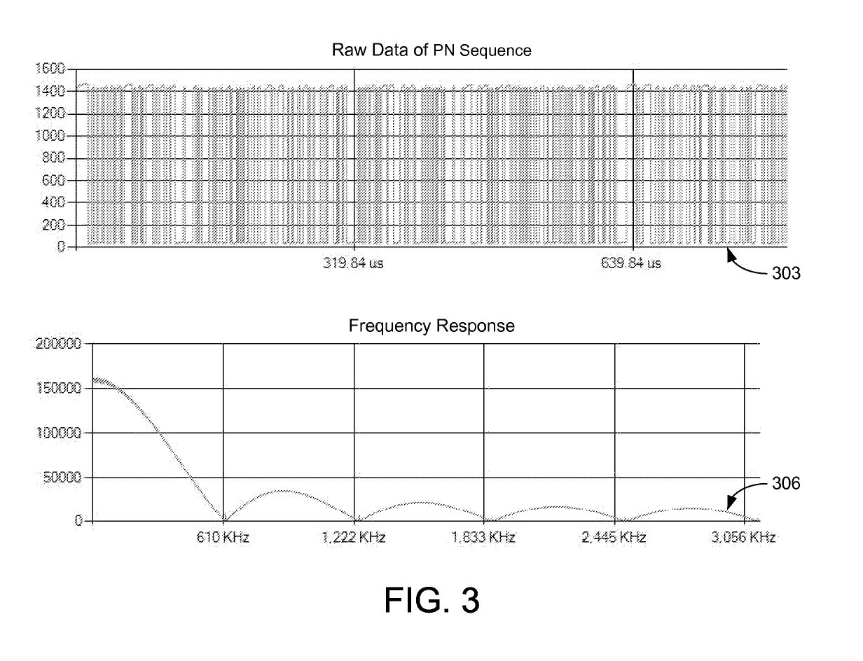

Referring next to FIG. 2, shown is an example of a system for synchronized PRS signal injection 106 into the power system 103. In the embodiment of FIG. 2, a synchronous pulse generator 203 provides periodic synchronization pulses based upon timing synchronization such as, e.g., a GPS clock. The periodic synchronization pulses are used to initiate the injection of a pseudo-random noise (PN) sequence into the power system 103 through power system interface 109a. Unlike a pure white noise signal (i.e., a purely random signal) with energy spread equally at all frequencies, the frequency response of a pseudo-random discrete interval binary signal is a classic sin(x)/x shaped waveform. An example of a PRS signal is illustrated in FIG. 3. A portion of the raw data 303 of a PN9 signal at a bit rate clock frequency of 625 kHz is depicted in the top trace. The resulting frequency spectrum 306 is shown in the bottom trace. The zero points on the frequency spectrum 306 occur at multiples of the bit rate clock frequency (i.e., n×625 kHz; n=1, 2, . . . ). Longer PN sequences have statistical characteristics that more closely approximate those of pure random noise waveforms and tend to produce better quality calculated impulse and frequency responses.

Referring back to FIG. 2, the periodic synchronization pulses are supplied for use by a PRS generator 206, which is configured to control the bit rate clocking and generation of the PRS. The PRS generator 206 may provide PRS at one or more bit length(s), e.g., PN9, PN10, PN11, and PN12 sequences, for injection into the power system 103. In some embodiments, PRS bit lengths range from PN6 to PN17 where the PN sequence length is 2ⁿ−1 for a selected PNn. In some implementations, the PN sequence length may be selectable.

The bit rate clock frequency may also be selectable from a range of frequencies. TABLE 1 provides examples of PRS durations at various bit lengths and bit rate clock frequencies that may be utilized. Higher bit rate clock frequencies tend to result in captured data that yields more detail in the calculated impulse and frequency responses.

TABLE 1

| Data sample rate at 10X | | 40 | ns | 80 | ns | 160 | ns | 320 | ns | 640 | ns |
|---|---|---|---|---|---|---|---|---|---|---|---|
| PRS bit clock period | | 400 | ns | 800 | ns | 1600 | ns | 3200 | ns | 6400 | ns |
| PRS bit clock frequency | | 2.5 | MHz | 1.25 | MHz | 625 | kHz | 312.5 | kHz | 156.25 | kHz |
| | Bit length | | | | | | | | | | |
| PN9 | 511 | 204.4 | μs | 408.8 | μs | 817.6 | μs | 1.64 | ms | 3.27 | ms |
| PN10 | 1023 | 408.8 | μs | 817.6 | μs | 1.64 | ms | 3.27 | ms | 6.55 | ms |
| PN11 | 2047 | 817.6 | μs | 1.64 | ms | 3.27 | ms | 6.55 | ms | 13.10 | ms |
| PN12 | 4095 | 1.64 | ms | 3.27 | ms | 6.55 | ms | 13.10 | ms | 26.21 | ms |

The duration of the PRS is the bit clock period times the bit length of the sequence. Cross-correlations of impulse responses are more effective when the duration of the PRS is longer than the response of the power system 103 to an impulse. So the combination of bit rate and sequence length should be chosen such that the PRS length in time exceeds the total time for a system's impulse response to die out. In the examples of TABLE 1, the PRS durations range from a duration of 204.4 microseconds to 26.21 milliseconds.

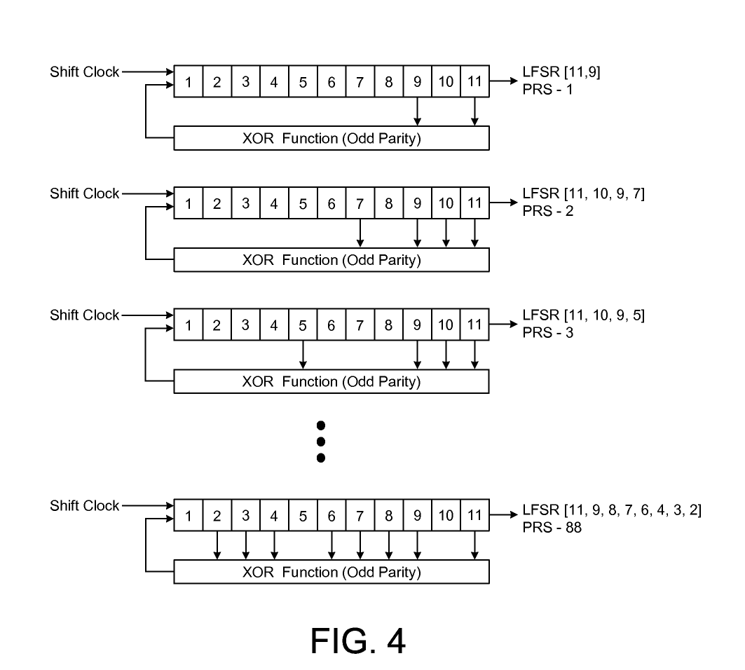

FIG. 4 illustrates an example of generating various uncorrelated PRS signals in the PRS generator 206 using a linear feedback shift register (LFSR) in accordance with various embodiments of the present disclosure. In the embodiment of FIG. 4, an 11-bit LFSR is used to produce PN11 sequences. A shift clock (e.g., the bit clock) is used to clock the shift register. An “exclusive OR operation” (XOR, odd parity) on selected output from the various stages of the shift register provides a feedback signal to the beginning stage of the shift register. Only certain selected outputs will produce maximum length LFSR sequences that are pseudorandom. In the case of the 11-bit LFSR of FIG. 4, 88 unique PN 11 sequences (PRS-1, PRS-2, PRS-3 . . . , and PRS-88) may be created.

Referring back to FIG. 2, the PRS is supplied to a binary drive control 209 for injection of the PN sequence into the power system 103 at a low voltage level (e.g., less that about 100 V). In some embodiments, the drive control 209 injects the PN signal at a low voltage level of about 100 V peak-peak, about 50 V peak-peak, about 25 V peak-peak, or at other low voltages as can be appreciated. The binary drive control 209 may continuously inject a stream of PRS signals separated from each other by a synchronizing pulse. A description of a PRS generator 206 and a binary drive control 209 of a PRS signal injection system 106 are provided in U.S. patent application Ser. No. 12/645,853, filed on Dec. 23, 2009 and entitled “Pseudorandom Binary Discrete Interal Noise Signal Generation and Injection on to the Electric Power Grid,” which is hereby incorporated by reference in its entirety. In one embodiment, the specifications of a binary drive control 209 include a frequency range from DC to about 1 MHz, a frequency response of less than +/−0.1 dB, distortion of less than 0.1%, a maximum voltage of about 140 Vrms (OC), a voltage gain of about 0 dB to about 40 dB, a variable DC offset of about 0V to +/−200V peak, continuous output power of about 75 Watts, and short circuit protection.

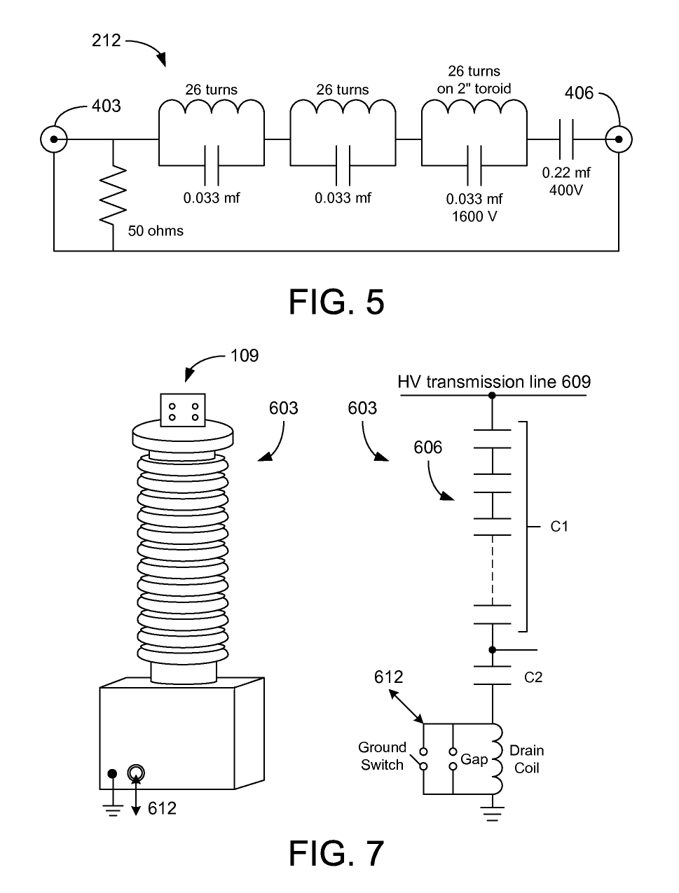

A signal conditioning interface 212a is provided between the power system interface 109b and the output of the binary drive control 209 to protect the PRS injection equipment from the power flow on the power system 103 (FIG. 1), as well as to avoid interference with power line carriers and transfer trip systems. FIG. 5 illustrates one example, among others, of a signal conditioning interface 212, which includes passive elements to provide protection. An R-C filter may be used for signal conditioning and passive series notch filters may be used to remove power line carrier signals. The embodiment of FIG. 5 depicts R-C signal conditioning with a 50 ohm resistor and a 0.22 uf capacitor and a three stage notch filter tuned to block the appropriate carrier frequency (or frequencies) such as, e.g., 179.5 kHz. Signals from the binary drive control 209 are obtained at connection 403 and conditioned signals are provided to the power system interface 109b from connection 406.

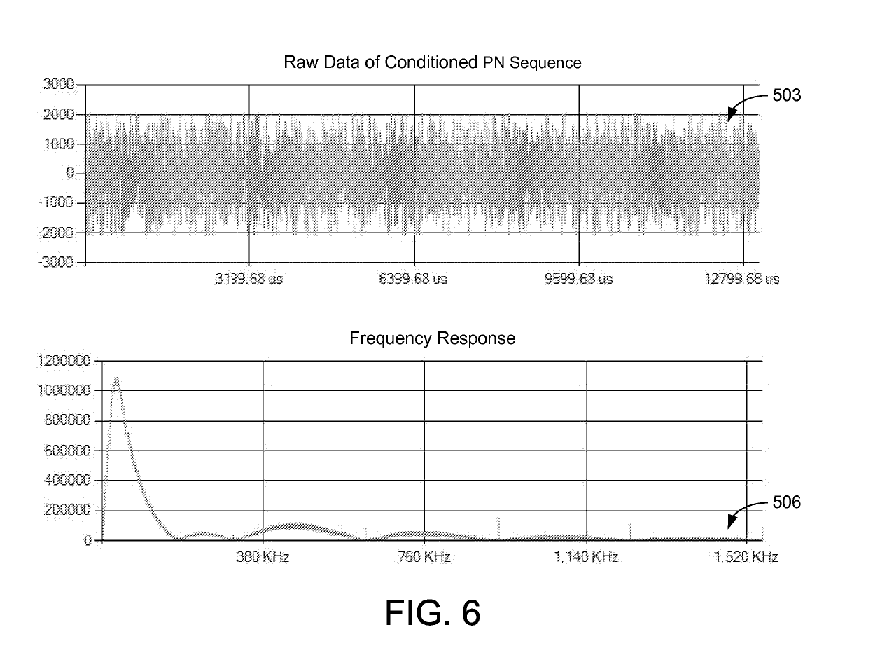

The use of a signal conditioning interface 212a (FIG. 2) will alter the PRS signal waveform injected into the power system 103 (FIG. 1). An example of the effect of the R-C signal conditioning and L-C notch filters tuned to 179.5 KHz is shown on a PRS signal is illustrated in FIG. 6. A portion of the raw data 503 of a conditioned PN10 signal at a bit rate clock frequency of 312.5 kHz is depicted in the top trace. The resulting frequency spectrum 506 is shown in the bottom trace. The zero points on the frequency spectrum 506 occur at multiples of the bit rate clock frequency (i.e., n×312.5 kHz; n=1, 2, 3 . . . ). The attenuation of the frequency spectrum 506 by the signal conditioning interface 212a can be clearly seen around 179.5 KHz. Due to the deterministic nature of the effects on the PRS signal, the effects of a signal conditioning interface 212 can be compensated for during analysis of the captured data based upon simulated and/or measured characteristics of the signal conditioning interface 212.

Referring back to FIG. 2, the conditioned PRS signal from the signal conditioning interface 212a is added to the power line carrier signals of the power system 103 through the power system interface 109a. A power system interface 109 may be, for example, a coupling capacitor voltage transformer (CCVT) that is coupled to the signal conditioning interface 212a and the transmission path 112 (FIG. 1) of the power system 103. FIG. 7 provides a graphical representation of an example of a CCVT 603 and a diagram illustrating a connection of the CCVT 603 to a high voltage transmission line 609 of the power system 103. A stack of capacitors 606 in the CCVT 603 facilitates injection of the low voltage PRS signal into a high voltage bus or transmission line 609. The conditioned PRS signal from the signal conditioning interface 212a is provided for injection across the drain coil of the CCVT 603 through connection 612.

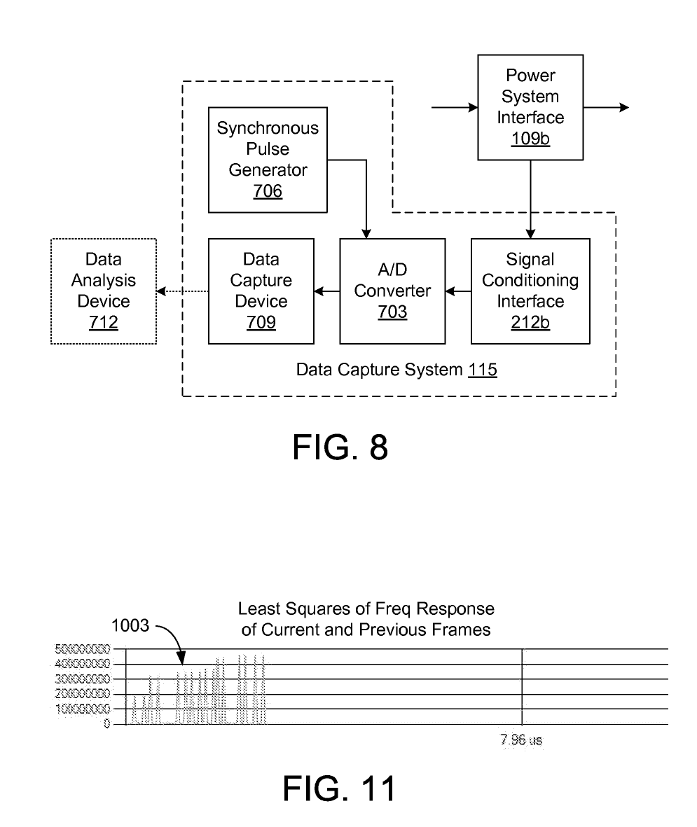

Referring next to FIG. 8, shown is an example of a system for synchronized data capture 115 from the power system 103. In the embodiment of FIG. 8, the response to the injected PRS signal is obtained through a power system interface 109b. A power system interface 109 may be, for example, a coupling capacitor voltage transformer (CCVT) 603 (FIG. 7) that is coupled to a signal conditioning interface 212b and the transmission path at point 118 (FIG. 1) of the power system 103. A stack of capacitors 606 (FIG. 7) in the CCVT 603 facilitates obtaining low voltage raw power system signal from the high voltage transmission line 609 (FIG. 7) or bus (e.g., with ratings in the kV range). The signal conditioning interface 212b receives the raw power system data from across the drain coil of the CCVT 603 through connection 612 (FIG. 7). The signal conditioning interface 212b protects the data capture and analysis equipment from the power flow on the power system 103 (FIG. 1), as well as to avoid interference with power line carriers and transfer trip systems. In the example of a signal conditioning interface 212 illustrated in FIG. 5, signals are taken from the CCVT 603 (FIG. 7) at connection 406 (FIG. 5) and conditioned signals are provided to an analog-to-digital (A/D) converter 703 from connection 403 (FIG. 5). The use of a signal conditioning interface 212b will alter the PRS response waveform from the power system 103 (FIG. 1). However, due to the deterministic nature of the effects on the PRS response, the effects of a signal conditioning interface 212 can be compensated for during analysis of the captured data based upon simulated and/or measured characteristics of the signal conditioning interface 212.

The PRS signal injection system 106 (FIG. 2) and data capture system 115 (FIG. 8) are synchronized to facilitate analysis of the captured raw power system data. As illustrated in FIG. 8, a synchronous pulse generator 706 provides periodic synchronization pulses based upon timing synchronization such as, e.g., the GPS clock. The periodic synchronization pulses are used by the A/D converter 703 to synchronously sample the raw power system data from the signal conditioning interface 212b. The sampled data may be buffered for capture. For example, a Picoscope ADC-212 or other device may be used to sample and buffer the raw power system data.

In response to a trigger, the raw power system data is captured and stored by data capture device 709. For example, capture may be triggered by the GPS clock (e.g., one pulse per second). Other triggers may be utilized as can be appreciated. In some implementations, a predefined amount of raw power system data may be block captured in response to the trigger. For example, the block size may be the PRS length×an oversample rate. In other embodiments, the amount of captured raw power system data may vary based upon the length of the PRS and/or other conditions of the power system 103. For example, the block size may be adjusted based upon the signal from the signal conditioning interface 212. In some embodiments, raw power system data corresponding to consecutive PRS signals in a stream of PRS signals are captured to determine the correlated impulse response. In some cases, buffering by the A/D converter 703 may allow capture of data that was sampled before triggering. In some embodiments, the ND converter 703 may be included in the data capture device 709.

Data capture device 709 may be, e.g., a hardware device, a data logger, a computing device such as, e.g., a laptop, workstation, smartphone, and/or from other computing device that is configured to execute a data capture application, or other device as can be appreciated. The data capture device 709 may also be configured to analyze the captured raw power system data (e.g., by execution of a data analysis application) or a separate data analysis device 712 (e.g., another computing device configured to execute a data analysis application) may obtain the captured raw power system data for analysis. In some implementations, the PRS signal injection system 106 and/or data capture system 115 may be adjusted based upon the captured and/or analyzed data to improve data capture. In some embodiments, the captured data may be stored in a data store for subsequent analysis.

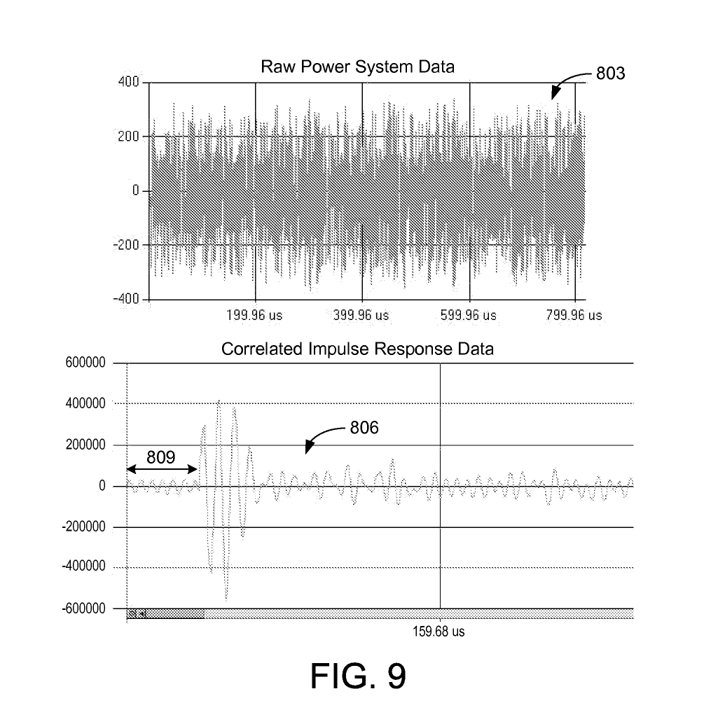

To begin, the captured raw power system data is cross-correlated with one or more PRS. FIG. 9 shows an example of a captured data waveform 803, which is the result of a PN11 signal with a bit clock period of 400 ns, and a correlated impulse response waveform 806. The correlated impulse response waveform 806 is determined by cross-correlating the captured raw power system data 803 with the injected PN11 sequence. In some implementations, the cross-correlation determination is calculated in real-time. The correlated impulse response waveform 803 may be used to determine a condition of the power system 103. For example, a condition of the power system 103 may be based at least in part upon undershoot, overshoot, ringing, delays, and/or other characteristics in the correlated impulse response waveform 803. In one embodiment, the delay 809 to the first spike in the correlated impulse response 803 corresponds to the propagation time of an actual impulse through, e.g., a transmission line. By evaluating changes in this delay 809, a condition such as, e.g., a change in transmission line length due to sagging may be determined. The condition of other components such as, but not limited to, CCVTs and carrier traps may also be determined using the correlated impulse response.

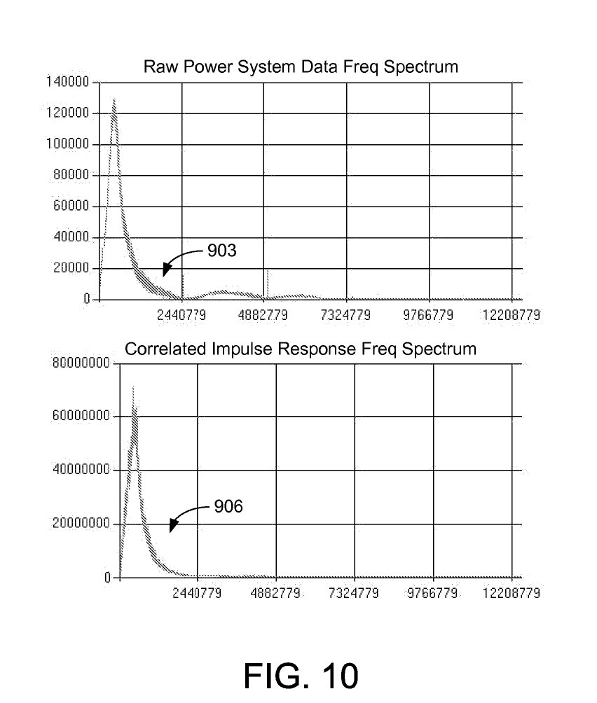

In response to the cross-correlation, a frequency spectrum of the correlated impulse response may then be determined. In some embodiments, the cross-correlation results may then be compared to a predefined threshold to determine if a correlation exists between the PRS and the captured data. FIG. 10 shows an example of a frequency spectrum 903 of the captured raw power system data 803 (FIG. 9) and a frequency spectrum 906 of the correlated impulse response waveform 806 (FIG. 9). A Fourier transform of the data 803 and 806 is used to determine each respective frequency spectrum 903 and 906. In some implementations, the frequency spectrum is calculated in real-time. Frequency spectrum(s) of correlated impulse response(s) may be used to determine a condition of the power system 103 (FIG. 1) as will be described below. For example, the frequency spectrum(s) and/or impulse response(s) may be used to determine the configuration of the power system 103 or the condition of a component of the power system 103. In some embodiments, a plurality of sequential frequency spectrums and/or impulse responses may be displayed for comparison and/or to illustrate trending of the impulse responses over time. In some embodiments, the impulse responses and/or frequency spectrums may be tiled on a display for viewing and analysis. Coordinated resizing of the display area of the tiles allows for easy comparison of displayed information.

In addition, least squares analysis of correlated impulse response waveforms and/or frequency spectrums may also be used to determine condition of the power system 103. For example, the least squares difference 1003 between the two most recent impulse response waveforms (and/or frequency spectrums) may be calculated as illustrated in FIG. 11. Excursions in the least squares difference 1003 indicate a change in the power system 103 while constant values illustrate repeatability of the impulse responses (and/or frequency spectrums). In some embodiments, a plurality of sequential least squares differences 1003 may be displayed to illustrate trending of the impulse responses (and/or frequency spectrums) over time.

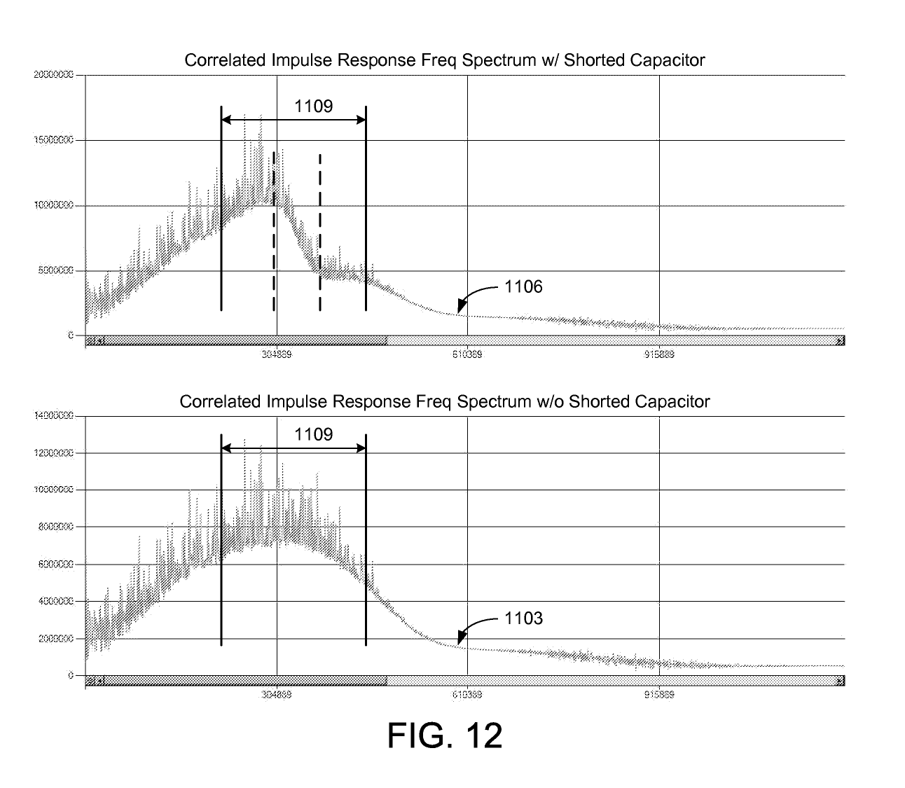

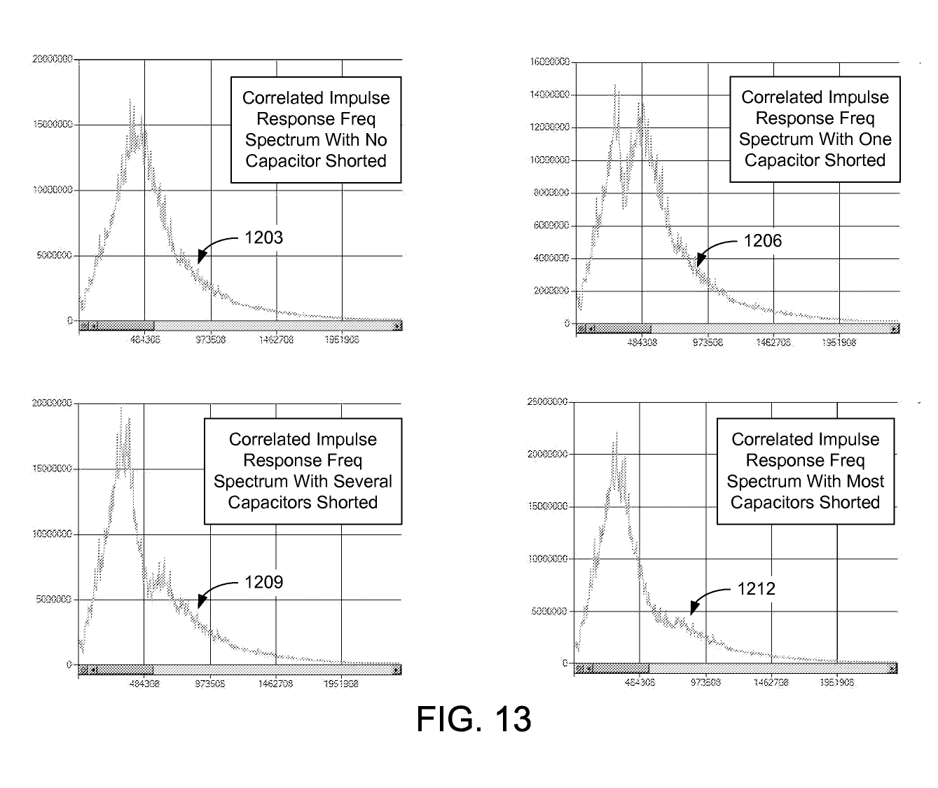

Referring next to FIGS. 12 and 13, shown are frequency spectrums of correlated impulse responses for a CCVT, such as the example illustrated in FIG. 7. The CCVT included 90 capacitor elements. The frequency spectrum 1103, presented at the bottom of FIG. 12, corresponds to the correlated impulse response of a PRS (a PN10 sequence with a 160 ns bit clock period) injected into a system including a CCVT without any shorted capacitors. The frequency spectrum 1106, presented at the top of FIG. 12, corresponds to the correlated impulse response of the PRS with one of the CCVT capacitors shorted. As can be seen in FIG. 12, the single shorted capacitor produces a detectable variation between the frequency spectrums 1103 and 1106.

The condition of the CCVT may be determined based upon characteristic frequencies and/or the impulse response associated with the CCVT. By using a range of frequencies 1109 (or sub-ranges of frequencies) as the characteristic frequencies, a pattern recognition algorithm or neural network may be used to determine the condition of the CCVT. For example, changes in the distribution of magnitudes within the characteristic frequency range 1109 may be associated with a condition of the CCVT by pattern recognition. In other implementations, a neural network may be trained to provide an indication of the CCVT condition based upon learned patterns within the frequency range 1109. Training data may be provided based upon measured data or from simulation results. In some embodiments, multiple characteristic frequency components (or frequency ranges) may be recognized a characterizing a component within the power system 103, and may be used to determine a condition (e.g., the presence of a fault) of the component.

The frequency spectrums of FIG. 13 further illustrate the variations in the frequency response produced by shorting of various combinations of capacitors within the CCVT. The frequency spectrum 1203, presented at the top left of FIG. 13, corresponds to the correlated impulse response of another PRS (a PN9 sequence with a 400 ns bit clock period) injected into the system including a CCVT without any shorted capacitors. The frequency spectrum 1206, presented at the top right of FIG. 13, illustrates the impact on the frequency response to shorting one capacitive element. The frequency spectrums 1209 and 1212, presented at the bottom left and bottom right of FIG. 13, illustrates the impact on the frequency response to shorting several capacitive elements and most of the capacitive elements, respectively. The different patterns in FIG. 13 allow for classification and identification based upon the frequency response and/or the correlated impulse response of the CCVT.

Other components of the power system 103 (FIG. 1) also have characteristic frequencies that may be used to determine the condition of the power system 103 and/or one or more component(s) included in the power system. For example, the condition of capacitor banks, transformers, or other components may be determined using pattern recognition and/or neural network evaluation of the frequency spectrum of the correlated impulse response. In addition, power system 103 conditions including, but not limited to, circuit breaker and/or transmission line conditions may be identified based upon the frequency response and/or the correlated impulse response of the power system 103. For example, as circuit breakers are opened or closed the impulse response of the power system 103 will change, and thus may be used to determine the characteristics of the power system 103 and/or its components. The frequency spectrum characteristics associated with various components within the power system 103 may be determined through impulse response measurements and/or simulation of the component(s) and/or power system 103.

In some embodiments, multiple PRS are injected from different locations within the power system 103. The corresponding impulse responses may then be captured, cross-correlated, and used to determine the condition(s) of the power system 103. In some cases, the impulse responses of two or more PRS may be simultaneously captured by a data capture device 709 (FIG. 8) in a single set of captured data. If the PRS corresponding to the simultaneously injected PRS signals are uncorrelated, the captured raw power system data can be cross-correlated with each of the uncorrelated PRS to determine the impulse response and frequency spectrums associated with each PRS. If multiple uncorrelated PRS are injected at the same time from different locations, the data capture device 709 can be triggered in synchronization with the first PRS signal. The GPS clock triggers both injection and capture simultaneously. The impulse response corresponding to the different PRS may be analyzed from the same set of captured raw power system data based upon cross-correlation with each of the uncorrelated PRS. For example, there are 88 unique PN 11 sequences. Therefore, 88 different PN 11 sequences may be injected at 88 different locations around the power system. By cross-correlating each sequence with the raw power system data captured at a single point on the power system, the impulse and frequency response can be calculated between the capture point and each of the 88 different injection points. The stored data may include information identifying the corresponding PRS.

In addition, the calculated impulse response corresponding to a single PRS may be captured in a plurality of locations within the power system 103. The frequency spectrums corresponding to the calculated impulse response may be used to determine the conditions of various components distributed within the power system 103 as described above. Similarly, a plurality of uncorrelated PRS may be injected at various points in the power system 103. Raw power system data may be captured at the same or different points and cross-correlated with the uncorrelated PRS to determine one or more condition(s) of the power system 103.

Raw power system data and/or calculated impulse response data may be stored in a data store for subsequent analysis. In addition, power system conditions may be associated with the stored data to identify conditions in the power system 103 based upon pattern recognition or other methods. In some implementations, captured power system data may be used to provide real-time indications of power system condition(s) and/or control inputs for power system operation. Stored data may also be used for subsequent analysis and identification of power system condition(s).

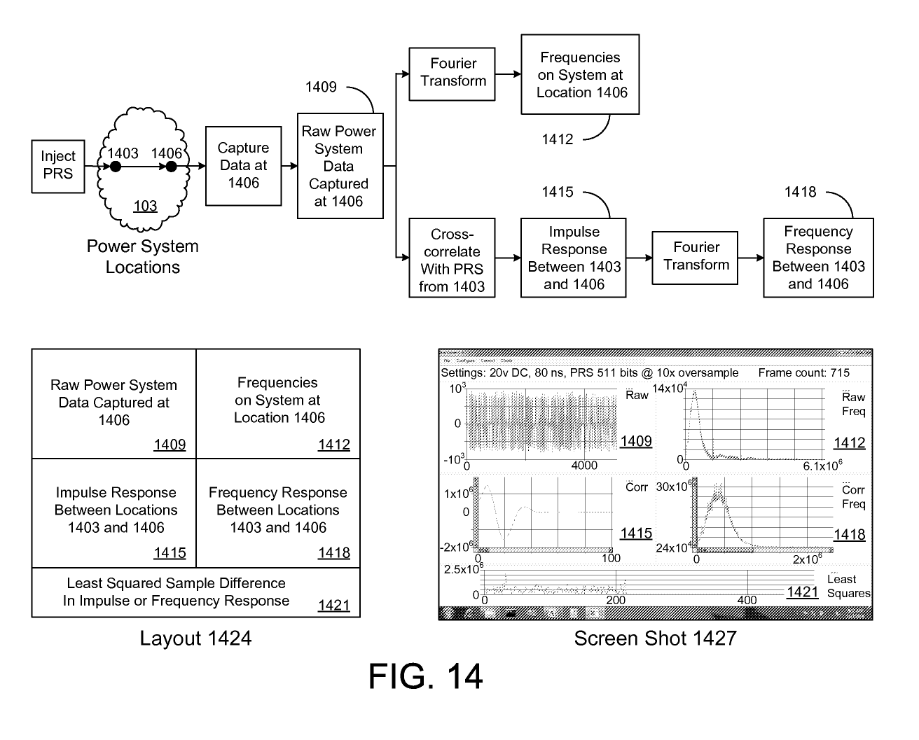

Referring to FIG. 14, shown is an example of real-time power system impulse and frequency response monitoring in accordance with various embodiments of the present disclosure. In the example of FIG. 14, a PRS is injected at a first location 1403 in a power system 103 using a PRS signal injection system 106 (FIG. 1). Raw power system data 1409 is captured at a second location 1406 in the power system 103 using the data capture system 115 (FIG. 1). The PRS signal injection system 106 and the data capture system 115 are synchronized to facilitate analysis of the captured data 1409. In some implementations, the raw power system data 1409 is stored in a data store and/or memory for subsequent off-line analysis as will be discussed. As can be understood, real-time monitoring and analysis may be applied to the captured raw power system data associated with other injection/capture locations within the power system 103.

The captured raw power system data 1409 may be further processed for real-time monitoring. For example, a Fourier transform of the captured data 1409 can provide frequencies 1412 on the power system 103 at location 1406. The captured data 1409 may also be cross-correlated with the PRS injected at location 1403 to provide the impulse response 1415 between locations 1403 and 1406. A Fourier transform of the impulse response 1415 can provide a frequency response 1418 of the power system 103 between locations 1403 and 1406. A least squared sample difference 1421 between the current and a previous impulse response 1415 and/or frequency response 1418 may also be calculated. Some or all of the determined power system information (e.g., the captured raw power system data 1409, the power system frequencies 1412, the impulse response 1415, the frequency response 1418, and/or the least squared sample 1421) may be used to determine a condition of the power system 103.

Graphical representations of the determined power system information may be generated and provided for rendering on a display device. FIG. 14 illustrates an example of a window layout 1424 for rendering on the display device. The window layout 1424 provides for monitoring and analysis of the current condition of the power system 103 and indications of changes in the power system 103 based upon the determined power system information 1409-1421 corresponding to locations 1403 and 1406. Screen shot 1427 depicts an example of a rendered window including the power system information 1409-1421 using layout 1424.

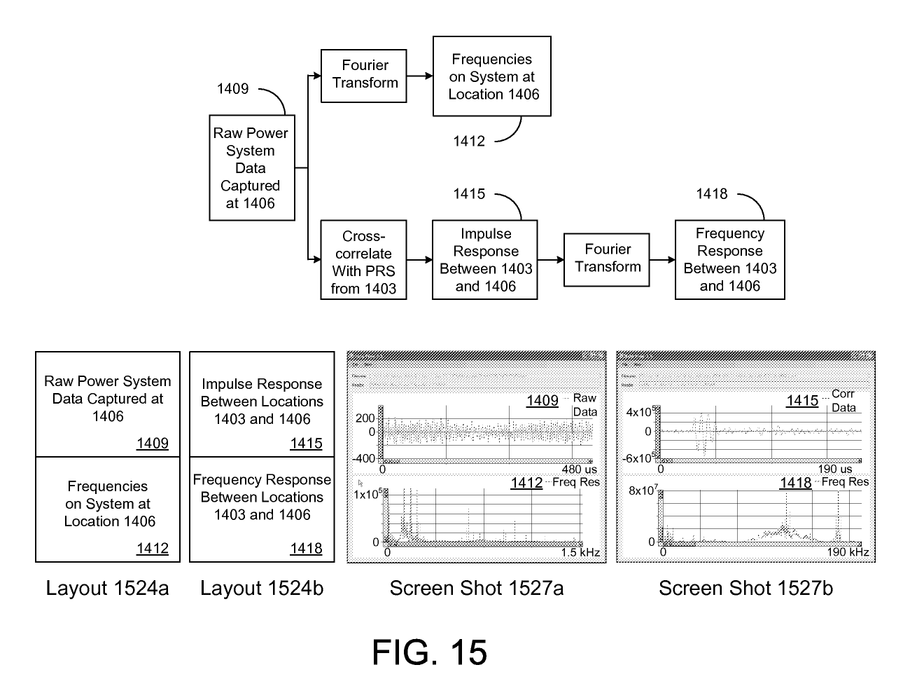

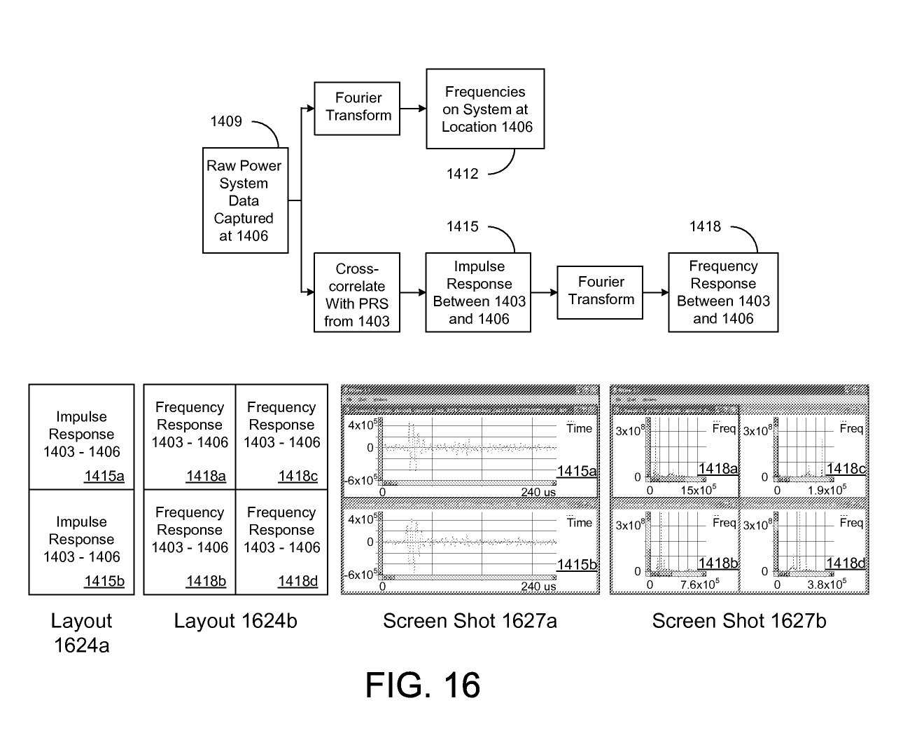

Referring now to FIGS. 15 and 16, shown are examples of off-line power system impulse and frequency response analysis in accordance with various embodiments of the present disclosure. For off-line analysis, captured raw power system data 1409 is obtained from a data store and/or memory. In the examples of FIGS. 15 and 16, reference is made to captured data 1409 injected at location 1403 and captured at location 1406 of power system 103 as illustrated in FIG. 14. As can be understood, off-line analysis may be applied to the captured raw power system data associated with other injection/capture locations within the power system 103.

The captured raw power system data 1409 is then processed for off-line analysis. As in FIG. 14, a Fourier transform of the captured data 1409 can provide frequencies 1412 on the power system 103 at location 1406. The captured data 1409 may also be cross-correlated with the PRS injected at location 1403 to provide the impulse response 1415 between locations 1403 and 1406. A Fourier transform of the impulse response 1415 can provide a frequency response 1418 of the power system 103 between locations 1403 and 1406. A least squared sample difference 1421 between the current and a previous impulse response 1415 and/or frequency response 1418 may also be calculated. Some or all of the determined power system information (e.g., the captured raw power system data 1409, the power system frequencies 1412, the impulse response 1415, the frequency response 1418, and the least squared sample 1421) may be used to determine a condition of the power system 103. In some embodiments, power system information for a plurality of injection/capture times may be determined for comparison and analysis to determine conditions and/or changes in the power system 103.

Graphical representations of the determined power system information may be generated and provided for rendering on a display device. FIG. 15 illustrates an example of two window layouts 1524 of power system information 1409-1418 for rendering on one or more display device(s). One layout 1524a provides for analysis of the condition of the power system 103 and indications of changes in the power system 103 based upon the determined power system information 1409 and 1412 corresponding to location 1406 at one injection/capture time. The other layout 1524b provides for analysis of the condition of the power system 103 and indications of changes in the power system 103 based upon the determined power system information 1415 and 1418 corresponding to locations 1403 and 1406 at the same injection/capture time. Screen shots 1527a and 1527b depict examples of rendered windows including the power system information 1409-1412 and 1415-1418 using layouts 1524a and 1524b, respectively.

FIG. 16 illustrates an example of two window layouts 1624 of power system information 1415-1418 for rendering on one or more display device(s). One layout 1624a provides for side-by side analysis of the condition of the power system 103 and indications of changes in the power system 103 based upon the impulse response 1415a and 1415b corresponding to locations 1403 and 1406 at different injection/capture times. The other layout 1624b provides for side-by side analysis of the condition of the power system 103 and indications of changes in the power system 103 based upon the frequency response 1418 corresponding to locations 1403 and 1406 at different injection/capture times. Screen shots 1627a and 1627b depict examples of rendered windows including the impulse response 1415 and frequency response 1418 using layouts 1624a and 1624b, respectively. In some embodiments, operations such as zooming or changing displayed ranges may be coordinated between window frames including the same power system information (e.g., impulse response 1415a and 1415b or frequency response 1418a-1418d) such that a modification to one frame is simultaneously carried out in all other frames including the same information. For example, impulse responses 1415a and 1415b can be displayed with the same scaling. If the displayed range of impulse response 1415a is adjusted, then the displayed range of impulse response 1415b simultaneously changes to the same scaling.

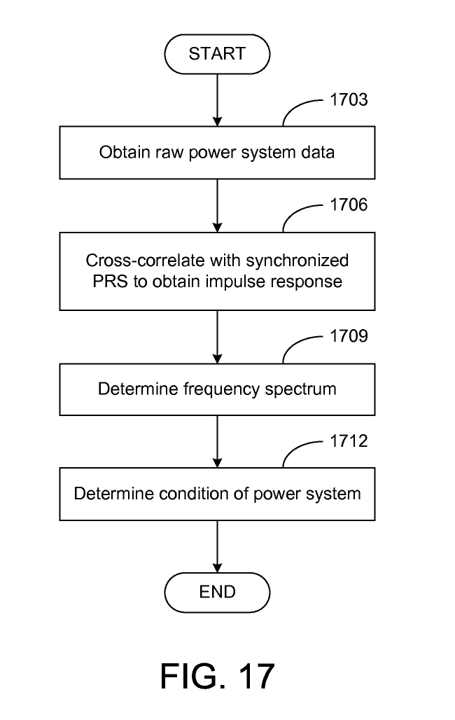

Referring next to FIG. 17, shown is a flowchart illustrating an example of functionality implemented as portions of the data capture and/or data analysis according to various embodiments of the present disclosure. It is understood that the flowchart of FIG. 17 provides merely an example of the many different types of functional arrangements that may be employed to implement the operation of the portion of the data capture and/or data analysis as described herein. As an alternative, the flowchart of FIG. 17 may be viewed as depicting examples of steps of a method implemented in the data capture device 709 and/or data analysis device 712 (FIG. 8) according to one or more embodiments.

In the implementation of FIG. 17, raw power system data is obtained from a power system 103 (FIG. 1) in block 1703. In block 1706, the raw power system data is cross-correlated with a synchronized pseudo-random sequence (PRS), which was injected into the power system 103. The synchronized PRS may be one of a plurality of uncorrelated PRS that have been injected into the power system 103. In some embodiments, the raw power system data is cross-correlated with each of the uncorrelated PRS. A frequency spectrum is determined in block 1709 based upon the cross-correlated impulse response. The determination of the frequency spectrum may be in response to the cross-correlation meeting some predefined criteria or threshold condition. In some implementations, a plurality of frequency spectrums are determined in response to the cross-correlations, where each of the frequency spectrums is based upon a cross-correlated impulse response corresponding to one of the uncorrelated PRS.

A condition of the power system 103 is determined in block 1712 based at least in part upon the one or more frequency spectrum(s), impulse response data, and/or other system characteristics. The condition of the power system 103 may include the configuration of the power system 103 and/or a condition of a component included in the power system 103. For example, the component may be a coupling capacitor voltage transformer (CCVT), transformer, circuit breaker, transmission line, carrier trap, or other component included in a power transmission system as can be appreciated. The condition may correspond to a current operating condition or an existing fault condition. For example, the condition may be a change in a transformer winding such as, but not limited to, changes in tap position, arcing or shorted turns, and/or shifting of the winding or core. The condition of the power system 103 may be determined based upon changes in characteristic frequencies and/or the correlated impulse response associated with at least a portion of the power system 103 and/or a component of the power system 103 using pattern recognition algorithms, neural networks, or other rule based identification methods as can be appreciated. The characteristic frequencies can include frequency components and/or frequency ranges of the frequency spectrum(s).

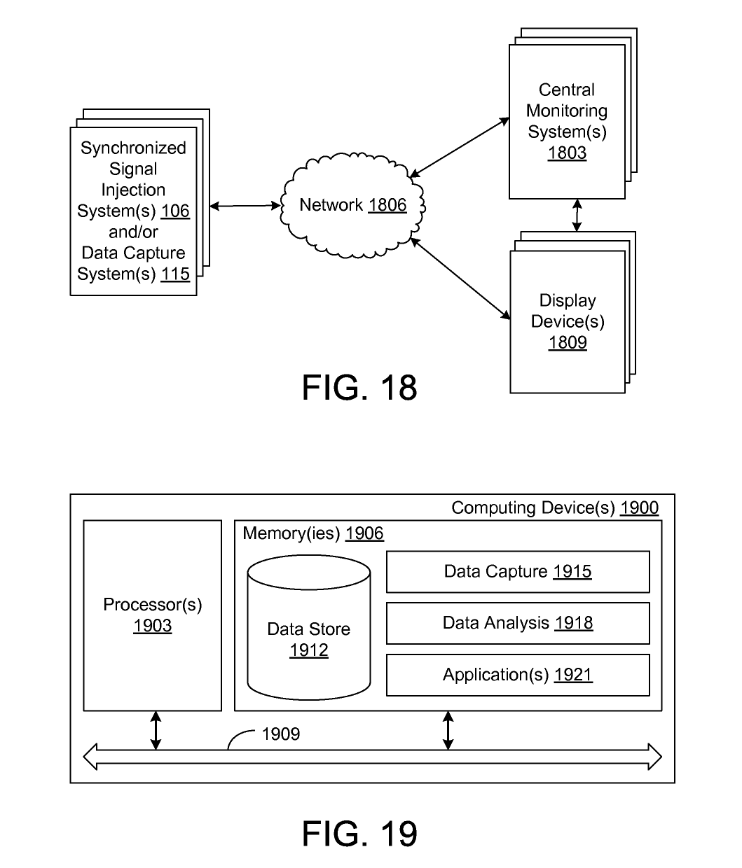

Referring next to FIG. 18, shown is a networked environment for synchronized PRS signal injection system 106 and/or data capture system 115. The synchronized PRS signal injection system(s) 106 and/or data capture system(s) 115 are located throughout the power system 103 (FIG. 1). The synchronized PRS signal injection system 106 and/or data capture system 115 may be in communication with one or more central monitoring system(s) 1803 through a network 1806. The network 1806 includes, for example, the Internet, intranets, extranets, wide area networks (WANs), local area networks (LANs), wired networks, wireless networks, power line carrier networks, or other suitable networks, etc., or any combination of two or more such networks. The synchronized PRS signal injection system 106 and/or data capture system 115 may operate independently or their operation may be coordinated by the central monitoring system(s) 1803. For example, the central monitoring system(s) 1803 may coordinate PRS injection into the power system 103 to facilitate capture of a single set of raw power system data for analysis. In some implementations, the raw power system data may be captured by a data capture device 709 and analyzed locally by a data analysis device 712 or remotely by the central monitoring system(s) 1803. The central monitoring system(s) 1803 may also obtain captured raw power system data and/or impulse response frequency spectrums from multiple locations for a coordinated analysis of the power system condition. In addition, the central monitoring system(s) 1803 may allow selection of PRS parameters such as PN sequence length, PN sequence pattern, PRS magnitude, and/or bit clock period or frequency. Graphical representations and/or interactive interfaces may be provided directly and/or through the network 1806 for rendering by display device(s) 1809. Graphical representations may be displayed from captured raw power system data before storing or may be displayed from previously stored data. For example, impulse response data and/or frequency spectrum data for one or more correlated impulse response(s) may be displayed during real time data capture or during off-line operation. In some embodiments, an interactive interface may allow for configuration of the PRS signal injection system 106 and/or data capture system 115 such as, but not limited to, selection of PNS length, injection voltage, timebase, number of samples, oversampling, captured data file location, buffer size, etc.

The central monitoring system(s) 1803 may include, but are not limited to, Energy Management Systems (EMS), Supervisory Control and Data Acquisition (SCADA) systems, or other monitoring systems as can be appreciated. Analysis of the impulse response frequency spectrums may be used to provide a real-time indication of the state of the power system 103 through the central monitoring system(s) 1803 as described in U.S. Pat. No. 7,848,897, entitled “Dynamic Real-Time Power System Monitoring” and issued on Dec. 7, 2010, the entirety of which is hereby incorporated by reference. The central monitoring system(s) 1803 may generate one or more graphical representation(s) and/or window(s) for rendering on display device(s) 1809.

The graphical window can provide control center users (i.e., operators, engineers, planners and coordinators) with a visual depiction of the condition of the power system 103. For example, a graphical representation of the power system 103 may include a color coded display corresponding to the condition of the power system 103 and/or components in the power system 103. These visual depictions may be geographically based, including the spatial orientation of the actual source locations collecting the impulse data from substations, generating plants and tie lines throughout the grid of the power system 103.

Overall impulse response parameters associated with the power system 103 such as, but not limited to, connectiveness and responsiveness may also be determined based upon the determined condition of the power system 103. In some embodiments, graphical representations of the impulse response, frequency spectrum, and/or least squares differences, as illustrated in FIGS. 9-11, may be generated for rendering on a display device 1809. The central monitoring system(s) 1803 may also use the condition of the power system 103 to automatically adjust the operation of the power system 103.

With reference to FIG. 19, shown is a schematic block diagram of a computing device 1900 according to various embodiments of the present disclosure. The computing device 1900 includes at least one processor circuit, for example, having a processor 1903 and a memory 1906, both of which are coupled to a local interface 1909. To this end, the computing device 1900 may comprise, for example, at least one server computer or like device. The local interface 1909 may comprise, for example, a data bus with an accompanying address/control bus or other bus structure as can be appreciated.

Stored in the memory 1906 are both data and several components that are executable by the processor 1903. In particular, stored in the memory 1906 and executable by the processor 1903 are a data capture application 1915, a data analysis application 1918, and/or other applications 1921. Also stored in the memory 1906 may be a data store 1912 and other data. In addition, an operating system may be stored in the memory 1906 and executable by the processor 1903.

It is understood that there may be other applications that are stored in the memory 1906 and are executable by the processor 1903 as can be appreciated. Where any component discussed herein is implemented in the form of software, any one of a number of programming languages may be employed such as, for example, C, C++, C#, Objective C, Java®, JavaScript®, Pen, PHP, Visual Basic®, Python®, Ruby, Delphi®, Flash®, or other programming languages.

A number of software components are stored in the memory 1906 and are executable by the processor 1903. In this respect, the term “executable” means a program file that is in a form that can ultimately be run by the processor 1903. Examples of executable programs may be, for example, a compiled program that can be translated into machine code in a format that can be loaded into a random access portion of the memory 1906 and run by the processor 1903, source code that may be expressed in proper format such as object code that is capable of being loaded into a random access portion of the memory 1906 and executed by the processor 1903, or source code that may be interpreted by another executable program to generate instructions in a random access portion of the memory 1906 to be executed by the processor 1903, etc. An executable program may be stored in any portion or component of the memory 1906 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1906 is defined herein as including both volatile and nonvolatile memory and data storage components. Volatile components are those that do not retain data values upon loss of power. Nonvolatile components are those that retain data upon a loss of power. Thus, the memory 1906 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1903 may represent multiple processors 1903 and the memory 1906 may represent multiple memories 1906 that operate in parallel processing circuits, respectively. In such a case, the local interface 1909 may be an appropriate network 1806 (FIG. 18) that facilitates communication between any two of the multiple processors 1903, between any processor 1903 and any of the memories 1906, or between any two of the memories 1906, etc. The local interface 1909 may comprise additional systems designed to coordinate this communication, including, for example, performing load balancing. The processor 1903 may be of electrical or of some other available construction.

Although the data capture application 1915, the data analysis application 1918, application(s) 1921, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 17 shows the functionality and operation of an implementation of portions of the data capture application 1915 and/or the data analysis application 1918. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 1903 in a computer system or other system. The machine code may be converted from the source code, etc. If embodied in hardware, each block may represent a circuit or a number of interconnected circuits to implement the specified logical function(s).

Although the flowchart of FIG. 17 shows a specific order of execution, it is understood that the order of execution may differ from that which is depicted. For example, the order of execution of two or more blocks may be scrambled relative to the order shown. Also, two or more blocks shown in succession in FIG. 17 may be executed concurrently or with partial concurrence. Further, in some embodiments, one or more of the blocks shown in FIG. 17 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the data capture application 1915, the data analysis application 1918, and/or application(s) 1921, that comprises software or code can be embodied in any non-transitory computer-readable medium for use by or in connection with an instruction execution system such as, for example, a processor 1903 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method, comprising:
obtaining, in at least one computing device, raw power system data associated with a power system;
cross-correlating, in at least one computing device, the raw power system data with a synchronized pseudo-random sequence signal injected into the power system to determine a correlated impulse response; and
determining, in at least one computing device, a condition of the power system based at least in part upon the correlated impulse response.

2. The method of claim 1, further comprising:
determining a frequency spectrum in response to the cross-correlation, the frequency spectrum based upon the correlated impulse response; and
determining a condition of the power system based at least in part upon the correlated impulse response.

3. The method of claim 1, wherein determining the condition of the power system comprises determining a condition of a component included in the power system.

4. The method of claim 3, wherein the component included in the power system is a coupling capacitor voltage transformer (CCVT).

5. The method of claim 4, wherein the condition is a shorted capacitor in the CCVT.

6. The method of claim 3, wherein the condition of the component is a change in a transformer winding.

7. The method of claim 3, wherein the condition of the component is a change in transmission line length due to sagging.

8. The method of claim 1, wherein the condition of the power system is based at least upon changes in the frequency spectrum at characteristic frequencies associated with at least a portion of the power system.

9. The method of claim 8, wherein the characteristic frequencies are associated with a component included in the power system.

10. The method of claim 8, wherein the characteristic frequencies are a range of frequencies of the frequency spectrum.

11. The method of claim 1, further comprising cross-correlating the raw power system data with at least one additional synchronized pseudo-random sequence signal injected into the power system.

12. The method of claim 11, further comprising determining at least one additional frequency spectrum in response to the cross-correlation with the at least one additional synchronized pseudo-random sequence signal, the at least one additional frequency spectrum based upon the correlated impulse response corresponding to the at least one additional synchronized pseudo-random sequence signal.

13. A system, comprising:
a plurality of signal injection systems coupled to a power system at a plurality of points, each signal injection system configured to inject a different one of a plurality of uncorrelated synchronized pseudo-random sequence signals into the power system;
a data capture device coupled to the power system, the data capture device configured to obtain raw power system data from the power system; and
a data analysis device configured to:
cross-correlate the raw power system data with at least one of the plurality of uncorrelated synchronized pseudo-random sequence signals;
determine a frequency spectrum associated with the at least one uncorrelated synchronized pseudo-random sequence signal, the frequency spectrum based upon a correlated impulse response corresponding to the at least one uncorrelated synchronized pseudo-random sequence signal; and
determine a condition of the power system based at least in part upon the frequency spectrum.

14. The system of claim 13, wherein the data analysis device is configured to cross-correlate the raw power system data with each of the plurality of uncorrelated synchronized pseudo-random sequence signals.

15. The system of claim 14, wherein the frequency spectrum is determined in response to a comparison of the correlated impulse response corresponding to the at least one uncorrelated synchronized pseudo-random sequence signal with a predefined threshold.

16. The system of claim 13, wherein the data analysis device is further configured to:
determine a frequency spectrum associated with a second of the plurality of uncorrelated synchronized pseudo-random sequence signals, the frequency spectrum based upon the correlated impulse response corresponding to the second uncorrelated synchronized pseudo-random sequence signal; and
determine a condition of the power system based at least in part upon the first and second frequency spectrums.

17. The system of claim 13, wherein the data analysis device is further configured to:
determine a frequency spectrum associated with a second of the plurality of uncorrelated synchronized pseudo-random sequence signals, the frequency spectrum based upon the correlated impulse response corresponding to the second uncorrelated synchronized pseudo-random sequence signal; and
determine another condition of the power system based at least in part upon the second frequency spectrums.

18. The system of claim 13, wherein the pseudo-random sequence signals are pseudo-random sequence signals having the same bit length.

19. The system of claim 13, wherein the pseudo-random sequence signals are simultaneously injected into the power system.

20. The system of claim 13, wherein the signal injection systems are coupled to the power system by power system interfaces.

21. The system of claim 13, wherein the data capture device and the data analysis device are the same device.

22. A non-transitory computer-readable medium embodying a program executable in a computing device, the program comprising:
code that obtains raw power system data associated with a power system;
code that cross-correlates the raw power system data with a synchronized pseudo-random sequence signal injected into the power system to determine a correlated impulse response; and
code that determines a condition of the power system based at least in part upon the correlated impulse response.
